(19) United States
(12) Patent Application Publication
(10) Pub. No.: US 2007/0217196 A1
(43) Pub. Date: Sep. 20, 2007

(54) Vented lighting system

(76) Inventor: Jeff Robert Shaner, Covington, GA (US)

Correspondence Address: NEEDLE & ROSENBERG, P.C., SUITE 1000, 999 PEACHTREE STREET, ATLANTA, GA, 30309-3915, US

(21) Appl. No.: 11/378,740

(22) Filed: Mar. 17, 2006

(51) Int. Cl. F21V 31/00; F21V 15/00

(52) U.S. Cl. 362/267; 362/362

(57) ABSTRACT

The invention relates to a lighting system that comprises a substantially environmentally sealable housing. The lighting system comprises a luminaire that is electrically connected to a power source via at least one electrical conductor at an electrical junction point. In one aspect, the lighting system further comprises a conduit through which the housing is in fluid communication with the electrical junction point.

### FIELD OF THE INVENTION

The present invention pertains to a lighting system. More specifically, the invention relates to an apparatus and method for venting a luminaire via a conduit.

### BACKGROUND OF THE INVENTION

Outdoor luminaires are subject to the hazards of the outdoor environment, including rain, humidity, dirt, and insects. Moisture is particularly bad for luminaires because of the electrical components housed therein. Conventionally, there are various way with which to control the effects of the environment on the operation of an outdoor luminaire.

One such design consists of sealing the housing of the luminaire from its surroundings. However, one of the consequences of such a design concerns dealing with the pressure changes within the luminaire housing. As one skilled in the art can appreciate, the pressure within the luminaire housing is a function of temperature, which is affected by the temperature of the environment, as well as the thermal energy dissipated by the lamp and other electrical components within the luminaire.

So as to not cause damage to the housing of the luminaire, the pressure changes must be managed. Some luminaire manufactures deal with such pressure changes by places “weep” holes in the bottom of the luminaire housing. Having the holes on the underside of the housing permits moist air and water droplets to flow therethrough. The moisture ingress is mitigated with the use of an additional device that partially covers the ‘weep’ holes, namely a flap of polymeric material that prevents the atomization of particles onto the electrical components when they are forced inside under the suction of a cooling housing. Additionally, if any water penetrates the housing, the weep holes facilitate drainage of the water but reduce its functionality by preventing the inverted mounting of the fixture.

This prior-art solution solves the differential pressure problem, but also causes another issue. As the luminaire cools, the pressure on the interior of the luminaire housing decreases, and atmospheric air is sucked into the housing from the exterior environment in order to equalize the differential pressure. Entrained within the air is particulate matter, moisture, and other debris. What is needed is an apparatus that keeps the interior of the luminaire substantially free from environmental intrusions, but also equilibrates the differential pressure between the interior and the exterior of the luminaire.

### SUMMARY

In one embodiment, the present invention pertains to a lighting system that comprises a substantially environmentally sealable housing. In one aspect, the luminaire is electrically connected to a power source via one or more electrical conductors. As one in the art will appreciate, the conductors may be in communication with a power source at an electrical junction point. The electrical junction point is located at a remote position from the housing and can be, for example, a junction box or a breaker box.

Since the luminaire housing may be sealed from the environment, there may be a desire to regulate and equalize the differential pressure between the interior of the luminaire housing and the environment on the exterior of the luminaire housing. Therefore, in one aspect, The lighting system further comprises a conduit through which the housing is in fluid communication with the electrical junction point.

### DETAILED DESCRIPTION OF THE DRAWINGS

These and other features of the preferred embodiments of the present invention will become more apparent in the detailed description, in which reference is made to the appended drawings wherein:

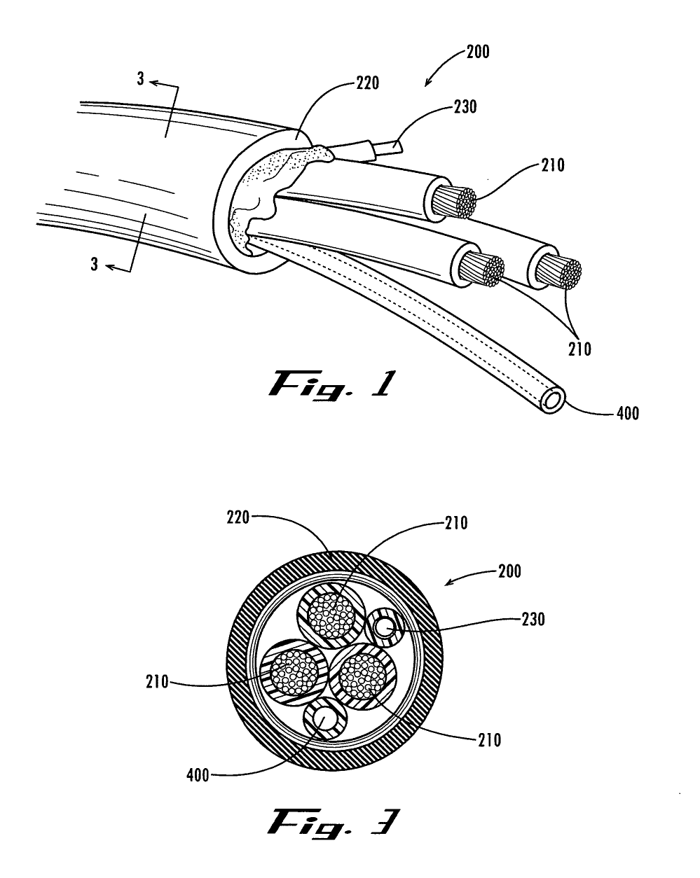

FIG. 1 is a perspective view of one embodiment of the present invention showing a cord for a lighting system having a plurality of conductors and a conduit.

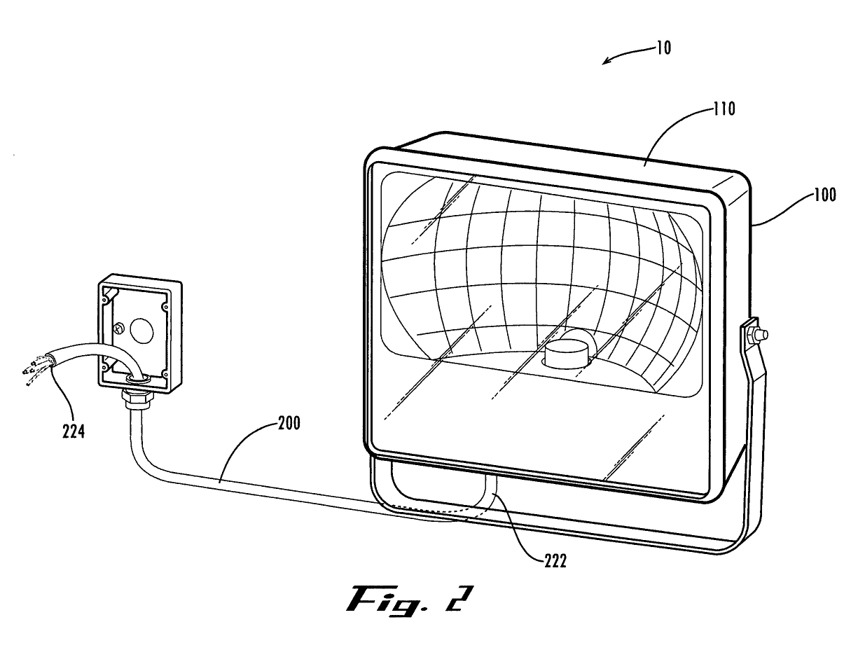

FIG. 2 is a front elevational view of the cord of FIG. 1.

FIG. 3 is a perspective view of one embodiment of the present invention showing a luminaire connected to an electrical junction point via an electrical cord.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “surface” includes aspects having two or more such surfaces unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The present invention may be understood more readily by reference to the following detailed description of preferred embodiments of the invention and the examples included therein and to the Figures and their previous and following description.

The present invention is a lighting system 10 that comprises a substantially environmentally sealable housing 110. In one aspect, the lighting system 10 comprises a luminaire 100 which is electrically connected to a power source via one or more electrical conductors 210. As one in the art will appreciate, the conductors may be in communication with a power source at an electrical junction point 300, and the luminaire 100 may comprise a ballast, which is electrically coupled to the electrical junction point via the electrical conductors. The electrical junction point 300 is located at a remote position from the housing 110 and can be, for example, a junction box or a breaker box.

As mentioned herein above, the luminaire housing may be sealed from the environment and, therefore, define a sealed interior cavity 120. As such, there may be a desire to regulate and equalize the differential pressure between the interior cavity 120 of the luminaire housing and the environment on the exterior of the luminaire housing. Therefore, in one aspect, the lighting system further comprises a conduit 400 through which the housing is in fluid communication with the electrical junction point. As one skilled in the art can understand and appreciate, the first end of the conduit 400 is positioned in fluid communication with the interior cavity of the housing 110, while the second end of the conduit is positioned in fluid communication with the electrical junction point. The conduit may comprise any number of materials known in the art such as, but not limited to, copper, aluminum, polyvinylchloride, polyethylene, stainless steel, and the like.

In one aspect of the invention, the lighting system also comprises an electrical cord 200 coupled between the housing and the electrical junction. The conduit may, for example, be substantially adjacent the electrical cord 200, or it may be enclosed within the cord itself.

In another aspect of the invention, the electrical cord may comprise at least one conductor substantially within a sheath 220. As one skilled in the art can appreciate, the conduit 400 may be adjacent the sheath, as described above, or the conduit may be substantially adjacent the electrical conductor and substantially enclosed within a sheath. The sheath 220 is configured such that the proximal end 222 is connected to the luminaire housing and the distal end 224 is connected to the electrical junction point. In such a configuration, the conduit is configured to enable passage of fluid between the housing and the electrical junction point 300, thereby equalizing the differential pressure. The one or more electrical conductors 210 may also include a ground conductor 230.

The preceding description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. The corresponding structures, materials, acts, and equivalents of all means or step plus function elements in the claims below are intended to include any structure, material, or acts for performing the functions in combination with other claimed elements as specifically claimed.

Accordingly, those who work in the art will recognize that many modifications and adaptations to the present invention are possible and can even be desirable in certain circumstances and are a part of the present invention. Other embodiments of the invention will be apparent to those skilled in the art from consideration of the specification and practice of the invention disclosed herein. Thus, the preceding description is provided as illustrative of the principles of the present invention and not in limitation thereof. It is intended that the specification and examples be considered as exemplary only, with a true scope and spirit of the invention being indicated by the following claims.

I claim:

1. A lighting system, comprising:
a substantially environmentally sealable housing;
an electrical junction point located at a remote position from the housing; and
a conduit having a first end and a second end, wherein the housing is in fluid communication with the electrical junction point via the conduit.

2. The lighting system of claim 1, further comprising an electrical cord coupled between the housing and the electrical junction point, wherein the conduit is substantially adjacent the electrical cord.

3. The lighting system of claim 1, further comprising at least one electrical conductor substantially within a sheath, wherein the electrical conductor is coupled between the housing and the electrical junction point, and wherein the conduit is substantially adjacent the electrical conductor and substantially enclosed within a sheath.

4. The lighting system of claim 1, wherein the electrical junction point is a junction box.

5. The lighting system of claim 1, wherein the electrical junction point is a breaker box.

6. A cord for a lighting system, comprising:
an elongate sheath having a proximal end and a distal end and substantially encasing a plurality of electrical conductors, wherein the proximal end is configured to connect to a substantially environmentally sealable luminaire housing and wherein the distal end is configured to connect to an electrical junction point; and
a conduit enclosed therein the sheath adjacent to at least one of the conductors, the conduit configured to enable the passage of fluid between the luminaire housing and the electrical junction point.

7. The cord of claim 6, wherein the electrical junction point is a junction box.

8. The cord of claim 6, wherein the electrical junction point is a breaker box.

9. A lighting system electrically coupled to an electrical junction point, comprising:
a substantially environmentally sealed housing that is spaced from the electrical junction point, the housing defining a sealed interior cavity;
a means for equalizing pressure between the interior cavity of the housing and the electrical junction point.

10. The lighting system of claim 9, wherein the means for equalizing pressure comprises a conduit having a first end and a second end, the first end of the conduit positioned in fluid communication with the interior cavity of the housing and the second end of the conduit positioned in fluid communication with the electrical junction point.

11. The lighting system of claim 10, further comprising:
a ballast positioned therein the lamp housing;
a means for electrically coupling the ballast to the electrical junction point.

12. The lighting system of claim 11, wherein the means for electrically coupling the ballast to the electrical junction point comprises an electrical cord coupled between the housing and the electrical junction point, wherein the conduit is substantially adjacent the electrical cord.

13. The lighting system of claim 9, wherein the electrical junction point is a junction box.

14. The lighting system of claim 9, wherein the electrical junction point is a breaker box.
